(19) United States
(12) Patent Application Publication
(10) Pub. No.: US 2003/0113513 A1
(43) Pub. Date: Jun. 19, 2003

(54) Decorative paper and method for impregnating one such a decorative paper

(76) Inventors: Dieter Dohring, Zabeltitz (DE); Anton Ott, Rosenheim (DE)

Correspondence Address: John W Renner, Renner Otto Boisselle & Sklar, 19th Floor, 1621 Euclid Avenue, Cleveland, OH, 44115, US

(21) Appl. No.: 10/257,228

(22) PCT Filed: Feb. 20, 2001
(86) PCT No.: PCT/EP01/01862

(51) Int. Cl. B32B 1/00; B05D 1/36; B05D 5/00

(52) U.S. Cl. 428/143; 427/402; 427/180; 427/258

(57) ABSTRACT

The invention relates to a process for the manufacture of a decorating paper with the following steps: application of resin and abrasion-resistant particles to the decorating paper and application of fibres and/or spherules to the abrasion-resistant particles.

In this manner, a decorating paper with aluminium oxide particles and/or silicon carbide particles on the upper decorated surface and, applied to the latter, a fleece embedded in a resin, comprising fibres with an average minimum length of at least 0.5 mm, preferably at least 2 mm, can be manufactured in a cost-favourable manner.

If the decorating paper is pressed together with a carrier board to form a panel, the press will be protected particularly well and cost-favourably from damage.

The invention discloses a process for impregnating a decorating paper and a decorating paper impregnated according to the process. Moreover, the invention discloses the manufacture and preparation of boards using the decorating paper.

A process for impregnating decorating paper is known from the specification WO 00/44984. The decorating paper is first moistened with an amino resin and is thereby impregnated. The quantity of the resin is regulated by means of a dosing roller. A layer made from an amino resin in a special dispersion is additionally sprayed onto the moistened, still wet decorating paper, whereby the final mass per area—relative to the dry mass of the un-treated paper—is 100% to 250%. The sprayed dispersion contains abrasive substances such as silicon carbide or corundum.

The impregnated decorating paper is used for the manufacture of boards and, indeed, especially for the manufacture of panels.

A panel, as known for example, from the specification EP 090 6994 A1, is generally a relatively long, thin board, which can be connected laterally to other panels, that is to say, along the longitudinal and transverse sides, for example, via tongue and groove connections. Panels connected with one another in this manner are used especially as floor coverings or for wall cladding.

According to the prior art, a panel may, for instance, be manufactured by a pressing process as follows. A film-like layer soaked in resin, which is known as a “counteracting paper”, is prepared. A carrier board is arranged above the counteracting paper. The “decorating paper” is applied to the top of the carrier board in such a manner that the decoration, with the abrasion-resistant materials corundum or silicon carbide facing outward and are visible from the outside. A layer made from cellulose and amino resin is additionally applied to the side with the silicon carbide or corundum. The cellulose layer is referred to as an “overlay”.

The decorating paper is then located between the carrier board and the additional layer providing the overlay. Following this, the counteracting paper, carrier board, decorating paper and additional layer are pressed together at a temperature in the order of magnitude of 200° C. The resin used begins to flow and poly-condenses to form a rigid network. After the layer system has been removed from the press, the resin hardens thereby providing the base element of a panel. Panels with the desired dimensions, and lateral tongues and grooves are manufactured from this base element by sawing and milling.

The carrier board provides the panel with mechanical stability. The decoration on the decorating paper determines the appearance of the subsequent wall or floor surface. The layer made from corundum or silicon carbide ensures good resistance to abrasion and similar. The counteracting paper counteracts any distortion of the carrier board during pressing. The overlay protects a surface of the press from the hard silicon carbide or corundum particles which would otherwise project by embedding these particles in amino resin.

For reasons of cost and quality, the preferred type of press is a double belt laminating press. Two metal belts are driven in a similar manner to a conveyor belt with the assistance of two rollers in each case. The belts are pressed against one another and heated. The layer system described above is introduced between the belts and compressed by them.

In spite of the overlay, the metal belts are still subject to damage by the corundum and silicon carbide, and as a result, the metal belts must be resurfaced. Resurfacing the belts is expensive and, under some circumstances, interrupts production during the resurfacing period. Moreover, the cellulose layer is cost-intensive.

The object of the invention is to provide improved decorating papers for the cost-favourable manufacture of boards.

The object of the invention is achieved through a process with the features of the first claim and through a decorating paper with the features of the co-ordinated claim. Advantageous embodiments are described in the dependent claims.

According to the process, decorating paper is impregnated and, in this context, is provided on one side not only with abrasion-resistant particles such as silicon carbide or corundum particles, but is additionally provided with fibres and/or spherules. By contrast with the abrasion-resistant particles, the fibres or spherules consist of soft materials such as polyester, polyamide or glass. During the pressing of a layer system, which comprises the decorating paper, the fibres and/or spherules protect a press belt from damage. It is not necessary to provide an overlay above a layer with abrasion-resistant particles. In this manner, approximately one-third of the costs incurred in the prior art for impregnation of the decorating paper, together with the application of a layer with the overlay, are saved.

In particular, impregnation of the decorating paper comprises the following steps. The decorating paper is soaked with a resin, especially an amino resin, and abrasion-resistant particles are applied to one side with the decoration. Following this, the fibres and/or spherules are applied. This ensures that in a pressing device the fibres and/or spherules form a protective covering layer over the abrasion-resistant particles.

Before the application of the fibres or spherules, the process may be designed as follows.

The decorating paper is first moistened with an amino resin with which it is impregnated. The quantity of resin is regulated by means of a dosing roller. A layer made from an amino resin in a special dispersion is additionally sprayed onto the moistened, still wet decorating paper, whereby the final mass per area—relative to the dry mass of the un-treated paper—is 100% to 250%. Spraying the dispersion has proved advantageous, as explained in the specification WO 00/44984. Following this, it is expedient to ensure a smooth and even distribution of the sprayed dispersion by means of rollers.

The above-named dispersion preferably consists of 100 parts of the amino resin, 20 to 95 parts abrasive, and therefore abrasion-resistant substance, 0.5 to 2.5 parts of a silane adhesion-mediator, 5 to 25 parts of an auxiliary flow agent, 0.1 to 0.4 parts of a wetting agent, 0.05 to 0.4 parts of a separating agent and an amino resin hardener.

In particular, a melamine resin is used as the amino resin; for example, polyglycol ether, E-caprolactam or butandiol may be used as the auxiliary flow agent, and, for example, silicon carbide with an average particle size of 60 to 160 μm or aluminium oxide in the form of corundum or from the molten bath with a particle size of 60 to 160 μm may be used as the abrasive substance. Any desired mixture of silicon carbide and aluminium oxide may also be provided.

The subsequent application of fibres and/or spherules is expediently implemented as follows. The mixture, made from a resin, the fibres and/or the spherules, is prepared and the mixture is then applied to the decorating paper treated as described above. The provision of a mixture further improves protection in the pressing device, because the additional resin contributes to the protective effect.

The thickness of the fibres or the diameter of the spherules should preferably be selected in such a manner that during the pressing of a corresponding layer system for the manufacture of boards, the corundum or silicon carbide particles are held remote from the corresponding surface of the press. In this manner, damage resulting from hard silicon carbide or corundum particles is avoided.

The average diameter of the spherules is preferably greater than the average diameter of the fibres, if both fibres and spherules are used. The spherules then provide the desired protective distance between the abrasion-resistant particles and, for example, a pressing belt. The fibres especially ensure the fixing of the resin and counteract the formation of cracks.

The relevant surface of a press is protected by the invention in an improved and particularly cost-favourable manner from damage through abrasion-resistant particles, for example, hard corundum or silicon carbide particles. The resurfacing of the relevant surfaces of a press—for example, a press belt of a so-called double belt laminating press—is required at correspondingly greater time intervals, so that costs and loss of production associated with resurfacing can be reduced. In general, considerable cost savings are achieved.

Typical fibre lengths are at least 0.5 mm, by preference, however, at least some millimetres, for example, 2 mm, 4 mm or 5 mm. The longer the fibre is, the better it is able to protect the surface of a board from the formation of cracks. An upper limit to the fibre length is provided, in particular, by the associated rise in viscosity. If the viscosity of a resin-fibre mixture is too high, it can no longer be processed. The diameter of the fibres is, for example, some 10 μm or also approximately 100 μm or more.

A typical diameter for the spherules is approximately 30 to 200 μm. On the one hand, this guarantees the desired distance between the corundum or silicon carbide particles and the corresponding surface in a press. On the other hand, the spherules are small enough not to be perceived with the naked eye.

The visual impression is not impaired by the fibres and/or spherules, if these provide the above-named dimensions and are embedded in the resin.

The fibres or spherules preferably consist of polyester, polyamide or glass as these materials provide the properties which are required during and after manufacture. During manufacture, they provide sufficient stability. Polyester, polyamide or glass are sufficiently soft materials, in the sense of the invention, in order to prevent damage to a pressing device. In a finished board, the above-named materials achieve sufficient transparency to avoid impairment of the visual impression of the decoration. Advantageously, the materials allow relatively long fibre lengths suitable for processing, which significantly exceed the length of fibres consisting of cellulose used according to the invention. The increase in viscosity with increasing fibre length of synthetic polymers such as polyester, polyamide fibres or glass fibres is slight by comparison with an increase in fibre length with cellulose fibres.

Long fibres can protect a press from damage better than short fibres. This applies in particular if the fibres are present in the form of a fleece, as will be explained in greater detail below.

The fibres and/or spherules may consist of different materials. For example, polyester fibres, polyamide fibres and glass fibres can be used at the same time.

Fibres are preferable to spherules because they help to prevent the formation of cracks in the surface. Spherules are therefore preferably used as a supplement. Consequently, by preference, hollow spherules consisting of glass are added as the spherules to reinforce the protective effect, by particular preference, for the reasons named above, spherules which provide a diameter of 30 to 200 μm.

The decorating paper according to the claims preferably provides a solid mass of 30 to 300 g/m². In particular, the fibre content is 5 to 100 g/m². Additionally, up to 80 g/m² spherules, especially micro-glass hollow spherules are provided for reinforcement.

In a further advantageous embodiment, the fibres are present in the form of a fleece. The fibres are, so to speak, woven together. A fleece provides particularly favourable reinforcement and protection; the risk of crack formation is a further reduced and accordingly the risk of damage to the relevant surface affected is also reduced. When a resin-fibre mixture is applied, the resin is fixed particularly well during pressing as a result of the fleece. In this context, the resin then contributes considerably to the additional protection of the pressing device.

When a fleece is provided, the protective effect is additionally enhanced by the inclusion of spherules.

The invention will be explained in greater detail with reference to the following examples:

Printed decorating paper with a mass of 70 g/m² is guided through an amino resin bath in such a manner that an application of 70 g/m² resin (solid content) is achieved. In this context, a commercially available amino resin is used. A corundum layer of 15 g/m² is applied evenly to the upper, decorated side. The now wet paper web is guided towards a fluid-bed drier. The predominant temperature in the drier is 170° C. A metered mixture of a commercially available amino resin and polyester fibres is applied to the wet web treated as described. The solid content of the substance applied is 70 g/m². The proportion of fibre in the mixture is approximately 30% by mass. The average length of the fibres is 5 mm. The average diameter is 80 μm. Following this, a second drying stage is carried out at 160° C., until a residual moisture of approximately 7% is present. The decorating paper impregnated in this manner is further processed as described above to form a board and, indeed, especially to form a flooring panel.

1. Process for the manufacture of a decorating paper with the following steps:
application of resin and abrasion-resistant particles to the decorating paper;
application of fibres and/or spherules to the abrasion-resistant particles.

2. Process according to claim 1, wherein the fibres and/or spherules are made from polyester, polyamide or glass.

3. Process according to any one of the preceding claims wherein the fibres and/or spherules are applied in a mixture with a resin.

4. Process according to any one of the preceding claims wherein the fibres provide an average length of at least 0.5 mm, preferably a length of at least 2 mm.

5. Process according to any one of the preceding claims, wherein the fibres are applied in the form of a fleece.

6. Process according to any one of the preceding claims, wherein the decorating paper is finally dried in a drier at a temperature above 100° C.

7. Process for the manufacture of a board, especially a panel for flooring, comprising the following steps: pressing a layer system in a pressing device, especially in a double belt laminating press, wherein the layer system comprises at least one decorating paper, manufactured according to any one of the preceding claims.

8. Process according to any one of the preceding claims, characterised in that the diameter of fibres and/or spherules is 30 to 200 μm, wherein preferably the average diameter of the spherules is greater than the average diameter of the fibres.

9. Process according to any one of the preceding claims, characterised in that the impregnated decorating paper is manufactured in such a manner that it provides a solid mass of 30 to 300 g/m².

10. Process according to any one of the preceding claims, characterised in that the proportion of fibres in the decorating paper is 5 to 100 g/m².

11. Process according to any one of the preceding claims, characterised in that the decorating paper provides up to 80 g/m² spherules.

12. Process according to any one of the preceding claims, characterised in that corundum or silicon carbide particles are sprayed onto the decorating paper and, preferably subsequently, the sprayed corundum or silicon carbide particles are distributed and/or smoothed by means of rollers.

13. Process according to any one of the preceding claims, characterised in that the layer system to be pressed comprises a counteracting paper, which lies within the-layer system on the side opposite to the decorating paper.

14. Process according to any one of the preceding claims, characterised in that the layer system to be pressed comprises a carrier board, which comprises, in particular, a wooden material such as MDF or HDF, or a coarse chipboard.

15. Decorating paper with aluminium oxide particles and/or silicon carbide particles on the decorated surface and a fleece embedded in a resin and applied to the latter, consisting of fibres with an average minimum length of at least 0.5 mm, preferably at least 2 mm.

16. Decorating paper according to any one of the preceding claims, wherein the fibres consist of polyester, polyamide and/or glass.

17. Decorating paper according to any one of the two preceding claims, wherein spherules are applied to the aluminium oxide particles and/or silicon carbide particles.

18. Board, which consists substantially of a wooden material, characterised in that fibres and/or spherules made from polyester, polyamide and/or glass are applied to the decorating paper layer on the upper surface of the panel.

19. Board according to the preceding device claim, wherein the fibres provide an average length of at least 0.5 mm, preferably at least 2 mm.

20. Board according to any one of the two preceding device claims, wherein a layer on the upper surface of the panel contains silicon carbide and/or corundum, wherein silicon carbide and/or corundum are arranged, especially substantially beneath the fibres and/or spherules.

21. Board according to any one of the preceding device claims 18 to 20, characterised in that the board forms part of a floor.
